(19) United States
(12) Patent Application Publication
(10) Pub. No.: US 2024/0367078 A1
(43) Pub. Date: Nov. 7, 2024

(54) A FILTER AND A METHOD OF MAKING A FILTER

(71) Applicant: NEMATIQ IP PTY LTD, Notting Hill, Victoria (AU)

(72) Inventors: Abozar AKBARIVAKILABADI, Notting Hill, Victoria (AU); Adam James FISCHMANN, Notting Hill, Victoria (AU); Shannon Paul PAPWORTH, Notting Hill, Victoria (AU)

(21) Appl. No.: 18/570,955

(22) PCT Filed: Jun. 15, 2022
(86) PCT No.: PCT/AU2022/050587

§ 371 Date: Dec. 15, 2023

(30) Foreign Application Priority Data
Jun. 15, 2021 (AU) 2021901786

(51) Int. Cl. B01D 39/20; B01D 29/13; B01D 39/16

(52) U.S. Cl. CPC B01D 39/2055; B01D 29/13; B01D 39/1692; B01D 2239/0478; B01D 2239/0681; B01D 2239/10; B01D 2239/1258

(57) ABSTRACT

The present invention relates to a filter and a method of making a filter. The filter includes a porous substrate and a graphene oxide membrane and can be used to filter fluids. The graphene oxide membrane includes a crosslinking additive that reduces degradation of the graphene oxide membrane on exposure to chlorine.

### RELATED APPLICATION

This application claims priority to Australian provisional application number 2021901786 filed on 15 Jun. 2021. The contents of the provisional application are hereby incorporated into the present specification.

### FIELD OF THE PRESENT INVENTION

The present invention relates to a filter and a method of making a filter. The filter includes a porous substrate and a graphene oxide membrane and can be used to filter fluids.

### BACKGROUND OF THE PRESENT INVENTION

A filter including a membrane consisting of layers of graphene oxide sheets, a two-dimensional material, is ideal for separating dissolved species based on molecular size (hydrodynamic radius). To increase the longevity over which the filter can be used ideally the filter can be cleaned using chemical cleaning processes. Chemical cleaning processes include the use of reagents such as chlorine bleach, hydrochloric acid and hydrogen peroxide. The use of chlorine bleach is most common, and includes hypochlorite (e.g. sodium hypochlorite, NaOCl), hypochlorous acid (HOCl) and chlorine (Cl₂), which are in equilibrium depending on pH. However, in order for the filter to be repeatedly cleaned and reused, the filter will require resistance to degradation by chlorine.

### SUMMARY OF THE PRESENT INVENTION

An embodiment of the present invention relates to a filter including a porous substrate and a graphene oxide filter membrane on the porous substrate, wherein the graphene oxide membrane includes a crosslinking additive that reduces degradation of the graphene oxide membrane on exposure to chlorine.

Without wanting to be limited by theory, the crosslinking additive can form tethers between the graphene oxide sheets.

The term “chlorine” used herein encompasses Cl₂, hypochlorous acid and salts of hypochlorite such as sodium hypochlorite.

The crosslinking additive is included in the graphene oxide membrane by being added to a suspension of graphene oxide sheets to form a composition prior to the composition being applied to the porous substrate.

The crosslinking additive may be included in the graphene oxide filter membrane by being applied to the graphene oxide filtering membrane after the membrane has been formed on the porous substrate. For instance, after the membrane has dried.

It is possible that the crosslinking additive may be included into the graphene oxide filter membrane by being added to a suspension of graphene oxide sheets prior to the suspension being applied to the porous substrate and by being applied into the graphene oxide filter membrane after the membrane has been formed on the porous substrate.

The filter may include an adhesive additive for adhering the graphene oxide membrane to the porous substrate, wherein the adhesive additive is resistant to chlorine degradation.

An embodiment of the present invention relates to a method of making a filter having a substrate and a graphene oxide membrane formed from a suspension containing graphene oxide sheets that has been applied to the porous substrate, and wherein the method includes incorporating a crosslinking additive in the graphene oxide membrane to reduce degradation on exposure to chlorine.

The step of incorporating the crosslinking additive in the graphene oxide filter membrane may include applying the crosslinking additive to the graphene oxide membrane once dried after the membrane has been applied to the porous substrate.

The step of incorporating the crosslinking additive in the graphene oxide filter membrane may include adding the crosslinking additive to suspension of graphene oxide sheets prior to the suspension being applied to the porous substrate.

A benefit in providing the embodiments of the present invention with chlorine resistance is that the graphene oxide membrane is resistant to degradation that is to say, reduces degradation, caused by chemical cleaners such as sodium hypochlorite (NaOCl) which is present in bleach. The terms “reduces degradation” and “chlorine resistance” mean that the filtration properties of the membrane, i.e. MWCO (molecular weight cutoff) and permeance, are retained after being exposed to chlorine at an amount of equal to or less than 120,000 ppm·h. For instance, the membrane may have a chlorine resistance in the range of 10,000 to 120.000 ppm·h. The graphene oxide membrane can therefore be cleaned using chlorine to remove fouling deposits that decrease the permeance and the efficiency of the filter. Typical polyamide membranes widely used for reverse osmosis and nanofiltration cannot be cleaned using chlorine as the chlorine will destroy the filtration properties, which limits the useful life of these membranes. Typically cleaning will be performed at a pH from 4 to 12. At low pH, the active species is hypochlorous acid, HOCl, and at higher pH the active species is hypochlorite, OCl⁻.

The crosslinking additive is selected from a group comprising: i) a polymer having at least one epoxide group, ii) a molecule having at least one epoxide group, iii) a cationic polymer having at least one quaternary ammonium group, iv) a polymer having at least two amine groups.

The crosslinking additive may be either a cationic polymer or an epoxide.

The crosslinking additive such as polyDADMAC can be applied to the dried graphene oxide membrane. In addition to chlorine resistance, the crosslinking additive may also provide a level of pH resistance to the graphene oxide membrane. The term “pH resistance” refers to the rejection of the filter and the membrane being less variable over a broader pH range than if no crosslinking additive was included in the graphene oxide membrane.

The method may also include a post treatment step in which the crosslinking additive, for instance an epoxide such as GLYMO, including activating the crosslinking additive to complete the crosslinking between the graphene oxide sheets.

In one example, activation can be carried out by heating the substrate and graphene oxide membrane on the substrate above 50° C. for at least 1 hour, and suitably to a temperature of 75° C. for at least 2 hours.

In another example, a catalyst such as aluminium acetylacetonate can be applied to the graphene oxide membrane by dip-coating, gravure printing, microgravure printing or rod coating. For dip-coating, a coupon of the graphene oxide membrane was submerged in a bath of the catalyst solution for a period of 5 minutes, after which the membrane was removed from the bath and dried at ambient temperature without washing.

The filter may include an adhesive additive that is resistant to chlorine for adhering the membrane to the porous substrate.

The method of making the filtration membrane may include applying the adhesive additive to the porous substrate so that the membrane is adhered to the substrate to resist chlorine degradation. In other words, the adhesive additive may be applied to improve the bonding of the filter membrane to the porous substrate, decreasing delamination of the graphene oxide from the porous substrate.

The step of applying the adhesive additive may occur before the suspension has been applied to the substrate. For example, the adhesive additive may be dip coated onto the substrate or applied by a printing method such as gravure printing including microgravure printing. The adhesive additive may be dried before the suspension is applied to the porous substrate.

The method may include adding the suspension of the graphene oxide sheets to the porous substrate after the adhesive additive has been applied to form the membrane.

Ideally, the porous substrate is also chlorine resistant.

Another embodiment of the present invention relates to a method of making a membrane for filtering a fluid, wherein the method includes:
applying an adhesive additive to a porous substrate; and
applying the composition to the porous substrate, wherein the composition has been made in accordance with the method described herein, and the adhesive additive facilitates adhesion of the composition to the substrate.

Yet another embodiment of the present invention relates to a filter for filtering a fluid, the filter having a porous substrate, the composition as described herein applied to the substrate, and an adhesive additive that facilitates bonding of the composition to the porous substrate.

### DETAILED DESCRIPTION

The term “membrane”, “filtration membrane” and “graphene oxide membrane” and variations thereof may be used interchangeably and embrace layers of the graphene oxide sheets on a substrate. Although it is ideal that the membrane be continuous over the substrate, it is possible that small areas of no graphene oxide sheets are present, similarly, there may be small areas of little to no overlapping of the graphene oxide sheets on account of the mechanism by which the composition is applied to the substrate.

### Crosslinking Additive

The purpose of the crosslinking additive is to minimise delamination of the graphene oxide sheets and improve membrane integrity. Without wishing to be bound by theory, the crosslinking additive forms crosslinks between the graphene oxide sheets. The crosslinks may be the result of any form of suitable bonding including covalent bonds, ionic bonds, electrostatic bonds, van der Waals bonds and so forth. In practice, the crosslinking additive forms extendible tethers between the sheets that allows for some change in spatial separation between the sheets, but generally speaking, the crosslinking additive makes the spatial separation and therefore the rejection and filtering properties of the graphene oxide membrane more consistent across different conditions. For instance, in the absence of the crosslinking additive, we believe that the rejection of the graphene oxide composition, when dried, which relates to the spacing between the graphene sheets, increases significantly as acidity increases and similarly the rejection of the graphene oxide membrane decreases significantly as the alkalinity increases. However, the changes in rejection are far more stable when the crosslinking additive is added to the composition (or applied to the composition after the composition after the composition has been applied to the substrate). In other words, a benefit of the crosslinking additive is that the composition provides more reliable rejection properties over a greater range of pH conditions.

The term “rejection” of the composition relates to the spacing between the graphene oxide sheets in a membrane. That is to say, rejection of the graphene oxide composition is more consistent across a range of pH when a crosslinking additive is used.

The method may include applying a crosslinking additive to the composition after the composition has been applied to the substrate and dried. A suitable crosslinking additive that can be added may be a cationic additive such as polyDADMAC

### Epoxy-Containing Crosslinking Additive

The crosslinking additive may be a molecule or polymer with an epoxide group that reacts with and bonds to graphene oxide sheets. In addition to an epoxide group, the crosslinking additive may also have a second reactive group that can self-react to crosslink graphene oxide sheets. For instance, the second reactive group may be an alkoxysilane that can form covalent bonds with the alkoxysilane group of another crosslinking additive bound to another sheet of graphene oxide. An example of a molecule having an epoxide group and a hydrolysable silanol group is 3-glycidyloxypropl trimethoxy silane, which is also known as GLYMO.

The crosslinking additive may have an epoxide group and in addition, have a cationic group that forms a non-covalent or ionic bond with the graphene oxide. For instance, the cationic group may be trimethylammonium. An example of a molecule having an epoxide group and trimethylammonium is glycidyltrimethylammonium chloride, which is also known as GTAC.

The crosslinking additive may also have multiple epoxide groups, such as a diepoxide that bonds with the graphene oxide. Example of molecules having multiple epoxide groups include: poly(ethylene glycol) diglycidyl ether, 1,4-butanediol diglycidyl ether, and poly(dimethylsiloxane) that is diglycidyl ether terminated. These examples are also examples of diepoxide molecules.

The epoxide containing crosslinking additives may be added to the composition. That is, prior to the composition being added to the substrate. An example of the epoxide containing crosslinking additive is GLYMO. The method may include activation of the crosslinking additive after the composition has been applied to the substrate. In one example, activation can be carried out by heating the substrate and composition on the substrate above 50° C. for at least 1 hour, and suitably to a temperature of 75° C. for at least 2 hours. In another example, a catalyst such as aluminium acetylacetonate, can be applied to the composition on the substrate as a solution, for example 1 g/L in 2-propanol.

### Cationic Polymer Crosslinking Additive

The crosslinking additive may also include a cationic polymer. In one example, the cationic polymer may have quaternary functionality by a quaternized nitrogen atom. For instance, quaternized ammonium.

The cationic polymer can also use a polymer compound with at least one quaternized ammonium structure within the principal chain. Examples of structural units that can be incorporated within the principal chain and contain an ammonium structure include pyridinium, piperidinium, piperazinium and aliphatic ammonium structures. Examples of other structural units that can be incorporated within the principal chain include methylene, ethylene, vinylene and phenylene units, and ether linkages. A specific example of this type of cationic polymer is poly(N,N-dimethyl-3,5-methylenepiperidinium chloride).

Examples of cationic polymers having quaternary functionality include cationic polyvinyl alcohol, cationic polyacrylamide, cationic poly-urea-ammonium-ether, cationic hydroxyethyl cellulose, cationic guar.

An example of a suitable cationic polymer is a modified polyvinyl alcohol incorporating one or more quaternary ammonium groups, such as GOHSENX™-K, from Mitsubishi Chemical, Japan.

Another example includes guar or hydroxyethyl cellulose that has been cationically modified, for example JAGUAR OPTIMA, which is available from Solvay S. A. (Belgium). Structures of these polymers may be represented as shown in Table 1.

TABLE 1
Cationic polymers

| Description | Structure |
|---|---|
| Cationic guar hydroxypropyltrimon- ium halide, such as a chloride | 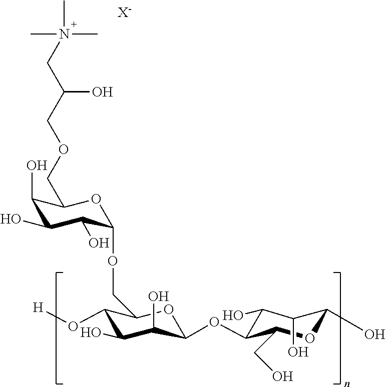 |
| Cationic guar gum, 2-hydroxy-3- (trimethylammonio)propyl ether, halide such as a chloride Commercially available from Solvay under the trade name Jaguar-Optima | 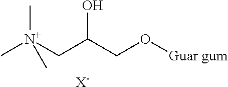 |
| Cationic hydroxyethylcellulose Commercially available from Sigma- Aldrich under the trade name Polyquaternium-10 | 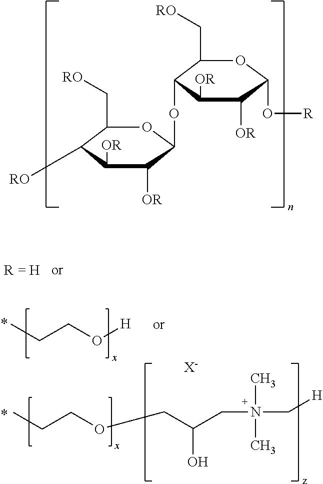 |
| Cationic Polyacrylamide with a quaternized nitrogen atom | 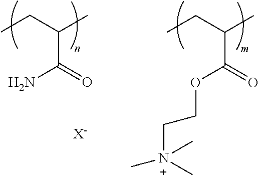 |
| Cationic polyDADMAC with a quaternized nitrogen atom Commercially available from Sigma- Aldrich under the trade name Polyquaternium-6 | 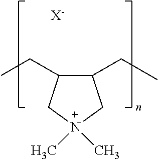 |
| Cationic poly(epihalohydrin-co- dimethylamine) with a quaternized nitrogen atom | 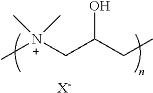 |
| Cationic poly(allylammonium halide) with a quaternized nitrogen atom | 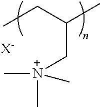 |
| Cationic poly urea-ammonium-ether Poly[bis(2-haloethyl) ether-alt-1,3- bis[3-(dimethylamino)propyl]urea] quaternized Commercially available from Sigma- | 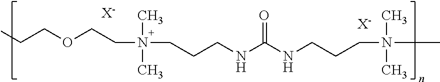 |
| Aldrich under the trade name | |
| Polyquaternium-2 | |
| Cationic polyacrylamide, very strongly | -AM(x)-DAC(y)-DMC(z)-DADMAC(a)- |
| cationic, high molecular weight | x + y + z + a = 1 and 0 < y + z + a < 1 and 0 < x < 1 |
| Commercially available from Sinofloc | That is to say, the cationic polyacrylamide has at least one AM group |
| under the trade name SINOFLOC 680 | and at least one DAC/DMC/DADMAC group. The structures of |
| | AM, DAC, DMC and DADMAC are shown in Table 2 |
| Cationic polyacrylamide, high cationic | -AM(x)-DAC(y)-DMC(z)-DADMAC(a)- |
| charge, ~70% | x + y + z + a = 1; and 0 < y + z + a < 1 and 0 < x < 1 |
| Commercially available from Hydroflux | That is to say, the cationic polyacrylamide has at least one AM group |
| under the trade name HB-2705 | and at least one DAC/DMC/DADMAC group. The structures of |
| | AM, DAC, DMC and DADMAC are shown in Table 2 |

In Table 1, the symbol X-may be any halide or salts, such as chlorides, bromides and iodides.

Examples of other possible cationic polymers include polymer compounds with an aliphatic quaternary ammonium structure:
a) poly(vinyltrialkylammonium halides) such as poly(vinyltrimethylammonium chloride),
b) poly(allyltrialkylammonium halides) such as poly(allyltrimethylammonium chloride), or
c) poly(oxyethyl-1-methylenetrialkylammonium halides) such as poly(oxyethyl-1-methylenetrimethylammonium chloride).

Examples of other possible cationic polymers include polymer compounds with a quaternary ammonium structure substituted with an aromatic hydrocarbon group:
d) poly(vinylbenzyltrialkylammonium halides) such as poly(vinylbenzyltrimethylammonium chloride)

Examples of other possible cationic polymers include polymer compounds with a quaternary ammonium structure incorporated within a heterocyclic structure:
e) poly(N-alkyl-2-vinylpyridinium halides) such as poly(N-methyl-2-vinylpyridinium chloride),
f) poly(N-alkyl-4-vinylpyridinium halides) such as poly(N-methyl-4-vinylpyridinium chloride),
g) poly(N-vinyl-2,3-dialkylimidazolium halides) such as poly(N-vinyl-2,3-dimethylimidazolium chloride),
h) poly(N-alkyl-2-vinylimidazolium halides) such as poly(N-methyl-2-vinylimidazolium chloride), or
i) poly(oxyethyl-1-methylenepyridinium halide).

Examples of other possible cationic polymers include a group of polymers comprising cationic monomers, as either homopolymers or copolymers, consisting of quaternized vinylpyrrolidone, methacrylamidopropyl trimethylammonium chloride, diallyldimethyl ammonium chloride (which is also known as DADMAC), allyl trimethyl ammonium chloride and, cationic copolymer of vinylpyrrolidone and of a quaternized vinylimidazol, and mixtures thereof. These monomers may also be co-polymerised with any chlorine-resistant non-cationic monomer or monomers.

The structure of these cationic monomers may be represented as shown in Table 2.

TABLE 2
Monomers that may be used in the production of cationic polymers

| Cationic monomer | Structure |
|---|---|
| Acrylamide (AM) | 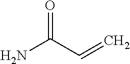 |
| Dimethylaminoethyl methacrylate | 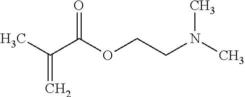 |
| [2-(Acryloyloxy)ethyl]trimethylammon- ium halide such as chloride (DAC) | 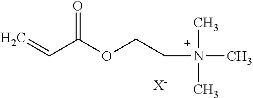 |
| [2-(Methacryloyloxy)ethyl]trimethyl- ammoniumhalide such as chloride (DMC) | 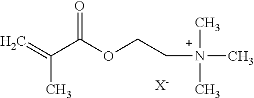 |
| Methacrylamidopropyl trimethylammon- ium halide such as chloride | 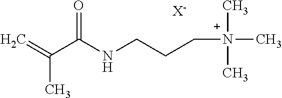 |
| Diallyl dimethyl ammonium halide such as chloride (DADMAC) | 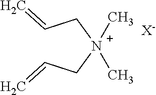 |
| acrylamidopropyltrimethyl ammonium halide such as chloride | 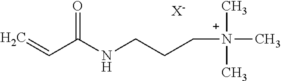 |
| Quaternised vinylimidazole | 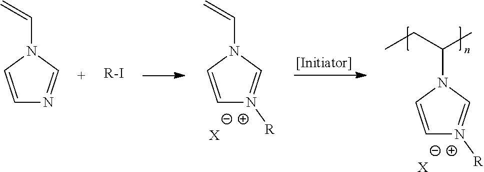 |

In Table 2, the symbol X may be any halide or salts, including chlorides, bromides and iodides.

### Diamine Crosslinking Additive

The crosslinking additive may include a molecule or polymer having at least two reactive amine groups so to form crosslinks between the graphene oxide sheets during the process of drying the composition. That is to say, the crosslinking additive may be a diamine polymer. We have found crosslinking additives containing amine groups may be chlorine resistant under acid conditions, which can be useful as some cleaning and bleaching procedures are carried out in acid conditions.

An example of a suitable diamine polymer is polyethyleneimine (PEI). Examples of suitable diamine molecules include: ethylene diamine, propylene diamine, butane diamine, hexamethylene diamine, p-phenylenediamine, and o-phenylenediamine.

### Adhesive Additives and Filtration Membrane

The step of applying the adhesive additive may occur before the composition has been applied to the substrate. For example, the adhesive additive may be dip coated onto the substrate or applied by a printing method such as microgravure printing.

The adhesive additive may include a polymer having a N(nitrogen) active cation. For instance, a quaternized nitrogen atom.

The adhesive additive may include a polymer having a cyclic structure having a N(nitrogen) substitution that provides an active cation.

The adhesive additive may include a quaternary ammonium group.

The adhesive additive may be a cationic polymer such as any one of those listed in Table 1 or Table 2 above (and the subsequent paragraphs). For example, the cationic polymer may be polydiallyldimethylammonium chloride (polyDADMAC).

In another example, the adhesive additive may be cationic polyvinylalchohol which is commercially available under the trade name GOHSENX™ K Series from Mitsubishi Chemical.

### Porous Substrate

The porous substrate may be made of any suitable polymer.

The porous substrate may be made of polymer including, one or a combination of polyolefin, polyvinyl, polycellulose, polysulfone, polyethersulfone, polyethylene, polypropylene, polyethyleneterephthlate, polyesters, polydimethyl siloxane, polytetrafluoroethylene, polyacrylonitrile, polyvinyl chloride.

In one example, the porous substrate may include polyvinylidene difluoride.

It is also possible that the porous substrate may be a metallic substrate or a ceramic substrate.

Examples of suitable substrates are commercially available from the following.
(a) Synder Filtration of the United States of America under the trade name Synder Bx
(b) Solecta Inc. (USA), under the trade name PVDF400.
(c) RisingSun Membrane Technology (Beijing) Co., Ltd. (China) as MF020.
(d) Membrane Technologies Inc. (USA) as PVDF HVF.
(e) Beijing OriginWater Technology Co., Ltd. (China) as Origin Water (MF022).
(f) TOMAC Corporation (Japan), under the trade name TCV-050/38A

### Reductant

The method may also include adding a reductant to the composition. The reductant may be used to partially reduce the graphene oxide and therefore change the interlayer spacing in the resulting graphene oxide membrane.

The reductant may include any suitable reductant including hydrazine, sodium borohydride, citrates, and alkali hydroxides such as sodium hydroxide and potassium hydroxide. In addition to a reductant, sulfuric acid may also be added.

The reducing solution may include any reductant containing hydroxyl groups that are miscible with the intermediate solution. Examples of the constituents include phenolic compounds, alcohol compounds or carboxylic compounds. The reductant may be benzenic. For instance, polyphenols, catechols, and so forth.

### pH Adjustment

The process may also include a step of adjusting the pH to make the composition stable depending on the crosslinking additives added to the composition. For example, the composition has a pH in the range of 8 to 12, and suitably approximately 10.5.

The step of adding the additive may also include mixing the composition until homogeneous.

### Setting the Permeance

The method may also include setting the permeance of the filtration membrane before first use to an extent permitted by the crosslinking additive.

Setting the permeance may include treating the filtration membrane with a solution of known pH for a period. The treating step may include submerging the filtration membrane in a bath of the solution. The solution may be an acid solution.

In the case of an acid solution, we believe the spaces between graphene sheets reduces which will reduce the permeance of the filtration membrane. Similarly, in the case of an alkaline solution, we believe the spaces between graphene sheets will increase and hence the permeance of the filtration membrane will increase. The extent to which the acid or alkaline treatment can adjust the spacing between the sheets, or the swelling between the sheets, is restricted by the crosslinking additive. Hence the degree of change brought about by the permeance setting step is also subject to the extent to which the crosslinks between the sheets can flex.

Setting the permeance may include treating the membrane for a period in the range of 3 to 20 minutes, suitably in the range of 5 to 10 minutes, and even more suitably for at least 5 minutes.

Setting the permeance may include treating the membrane with a solution having a pH ranging from 8.5 to 12, and suitably in the range of the 9 to 10.

Setting the permeance may include treating the filtration membrane with a NaOCl (bleach) solution of known pH for a period. Setting the permeance may include treating the filtration membrane with a bleach solution containing 10,000 mg/L of NaOCl at pH 4 for a period of 30 minutes.

### Viscosity and Surface Tension

The method may include adjusting either one or a combination of viscosity and/or surface tension of the composition to enable more effective printing. For example, polyphenol, surfactants or organic solvents may be added to the composition.

### Chlorine Resistance

By providing resistance to chlorine, as referred to herein as “chlorine resistance” the membrane is resistant to degradation caused by sodium hypochlorite (NaOCl) also known as bleach, which is used for cleaning the membranes to remove fouling deposits that decrease the performance of the membrane.

Degradation can occur by a breakdown in the graphene oxide membrane, that is between the sheets of the graphene oxide, and/or by a breakdown between the graphene oxide membrane and the substrate. Either form of degradation can also be described a delamination. Provided the membrane has sufficient pH resistance, the cleaning process can be performed at any pH. The cleaning may be done at a pH from 4 to 12. At low pH, the active species is chlorine (Cl₂), or hypochlorous acid, HOCl, and at higher pH the active species is hypochlorite, OCl⁻. The chlorine resistance of the membrane is limited by the choice of adhesive additive and crosslinking additive. Both the adhesive additive and the crosslinking additive, if used, must be chlorine resistant for the membrane to be chlorine resistant. Examples of chlorine resistant combinations include (a) GOHSENX-K (adhesive additive) and polyDADMAC (crosslinking additive), and (b) polyDADMAC (adhesive additive) and glymo (crosslinking additive). Chlorine resistance can be estimated by exposure of a membrane to a solution of sodium hypochlorite at a specified concentration for a specified amount of time (expressed as ppm·h), at a specified pH, and then measuring the permeance and rejection of the membrane in a cross-flow filtration test. Typically, a chlorine resistant membrane is one that can withstand being exposed up to 120,000 ppm·h of chlorine prior to performance degradation. Specifically, the membrane may be resistant to chlorine in a range of 10,000 to 100,000 ppm·h and has a rejection of at least 90% when rejection is tested using a Rose Bengal probe molecule or equivalent.

### Graphene Oxide Feed Suspension

A suitable graphene oxide feed suspension is commercially available from various suppliers, including: (i) William Blythe Ltd of the United Kingdom who sell a 10 mg/ml graphene oxide aqueous suspension having a variable sheet size under the trade name “GO Graphene”; (ii) ACS Materials, LLC of the United States of America, California, who sell a 10 mg/ml suspension and a 5 mg/ml graphene oxide water or ethanol graphene oxide suspension under the description “Single Layer Graphene Oxide Dispersion”; and (iii) Sigma-Aldrich who sell a 10 mg/ml graphene oxide water suspension under the trade name 906999.

When the feed suspension has been obtained from the sources mentioned in the paragraph above, the concentration of impurities in the feed suspension has not had a detrimental impact on the ability to form a composition that can be printed, or on the performance of the composition as a graphene oxide membrane of the filter. That is to say, the feed suspension may have an impurity concentration over a broad range. The concentration of impurities can be measured in various ways, one of which is measuring the electrical conductivity of the feed suspension. For example, the feed suspension may have an electrical conductivity as high as 2,500 μS/cm, or even higher. However, it is preferred that the graphene oxide feed suspension may have a conductivity of less than 2,500 μS/cm, or even be substantially free of impurities.

In one example, the feed suspension may have an electrical conductivity of less than 600 μS/cm, suitably a conductively of less than 550 μS/cm, and even more suitably a conductively of less than 500 μS/cm. Even more ideally, the graphene oxide suspension has an electrical conductivity of less than 450 μS/cm. When the feed suspension has an electrical conductivity of 450 μS/cm or less, the feed suspension is effectively free from any disruptive effects of salts, ions or other impurities.

The graphene oxide feed suspension may be prepared in a preliminary process step by combining a dry graphene oxide with water and mixing. Similarly, the graphene feed suspension may be prepared in a preliminary process step by combining dry graphite oxide with water and mixing. Dry graphene oxide includes a cake material with some proportion of graphene oxide and the balance being water.

The graphene oxide feed suspension may contain graphene oxide at a concentration in the range of 0.1 to 15 wt %, and suitably in the range of 0.5 to 10 wt %, and more suitably in the range of 0.5 to 8 wt %, even more suitably in the range of 1 to 5 wt %, and yet even more suitably in the range of 1 to 2 wt %.

In an embodiment the graphene oxide feed may be unmodified. That is to say the graphene oxide feed need not be treated to create imperfections, or change the size, shape, degree of oxidation of the graphene oxide sheets of the feed.

In an embodiment the graphene oxide feed may be treated with a modifying agent. Details of how this may be achieved are explained below.

### Modifying the Graphene Oxide Feed Suspension

The method may also include the steps of:
adding a modifying agent to a graphene oxide feed suspension containing graphene oxide sheets to form a composition; and
mixing the composition under elevated temperature conditions so that the modifying agent reacts with the graphene oxide sheets to create imperfections in the graphene oxide sheets, wherein progress of the reaction is stopped by reducing the temperature of the composition to stabilise the composition so that the composition can be applied to a substrate to form a graphene oxide filtration membrane.

A benefit of the method of the present invention is that any unreacted amount of the modifying agent in the composition does not need to be removed before the composition can be applied to a porous substrate to form a filtration membrane. That is to say, the composition does not need to undergo additional purification steps to remove excess modifying agent from the composition.

The terms “creating imperfections” or “create imperfections” in the sheets embraces a number of possible modifications to the sheets, including reducing the size of the sheets, and creating defects in the sheets such as creating holes in the sheets, and increasing the size of pre-existing holes in the sheets. A hole in the sheet is where the carbon-carbon lattice structure, at a molecular level, is disrupted. The introduction of imperfections in the graphene oxide sheets means that when the composition forms a membrane on a porous substrate, the membrane has a higher permeance than if no imperfections were present in the graphene oxide sheets.

The size of the sheets and the extent of pre-existing holes in the sheets in the feed suspension need not be precisely prescribed or analysed at a nanoscale level. In any event, we have found that the graphene oxide sheets may have a maximum diameter in the range of 4,000 to 40,000 nm. The pre-existing holes may be any size that is smaller than the sheets, and may for example, have a maximum diameter up to 500 nm. Some sheets may have no pre-existing holes, whereas other sheets may have any number of pre-existing holes. For example, the number of pre-existing holes in the size range up to 500 nm may be from 1 to 10.

Although the composition can be applied using a variety of techniques, one of the benefits of the present invention is that the composition can be printed or applied to a substrate which enables products to be made at high speed.

In the case of the filter embodiment, the graphene oxide sheets may have been modified by reacting with a modifying agent to create imperfections in the graphene oxide sheets at an elevated temperature wherein progress of the reaction is stopped by reducing the temperature of the composition to stabilise the composition so that the composition can be applied to a substrate to form a graphene oxide filtration membrane.

### Modifying Agent

The modifying agent may be added to the feed suspension in amounts so that all of, or nearly all of, the modifying agent reacts with the graphene oxide sheets.

The modifying agent may be added to the feed suspension at a mass ratio of modifying agent to the graphene oxide mass in the feed suspension is in a range of less than or equal to 1000 to 1, and suitably at a mass ratio of less than 500 to 1, or more suitably at a mass ratio of less than 250 to 1, or even more suitably at a mass ratio of less than 100 to 1, 50 to 1, 25 to 1, 15 to 1, 12 to 1, 10 to 1, 9 to 1, 8 to 1, 7 to 1, 6 to 1. The addition of the modifying agent may include mixing the modifying agent and the feed suspension in a composition of 10 to 3 parts modifying agent to 1 part graphene oxide of the feed suspension, and suitably mixing 5 parts modifying agent to 1 part graphene oxide of the feed suspension. In one example, the modifying agent may be added to the feed suspension in amounts of 4 parts modifying agent to 1 part graphene oxide of the feed suspension. In another example, the modifying agent may be added to the feed suspension in amounts of 3 parts modifying agent to 1 part graphene oxide of the feed suspension. In yet another example, the modifying agent may be added to the feed suspension in amounts of 2 parts modifying agent to 1 part graphene oxide of the feed suspension. In yet a further example, the modifying agent may be added to the feed suspension in amounts of 1 part modifying agent to 1 part of the graphene oxide of the feed suspension.

The ratio of modifying agent to graphene oxide in the composition may impact on the period of mixing of the mixing step. For instance, when less modifying agent is added to the composition, the period of mixing may be increased to effectively create imperfections in the sheets. Conversely, the period of mixing required to create imperfections may be reduced when a higher amount of modifying agent is added. The method may include controlling the ratio of modifying agent added to the graphene oxide of the feed suspension based on a predetermined period of the mixing.

The method may include controlling the period of mixing based on a predetermined ratio of modifying agent being added to the graphene oxide of the feed suspension. Suitably, the period of mixing may be in the range of 0.5 hr to 7 hrs, although mixing can be carried out for any period. For example, in a range from 1 hr to 6 hrs, suitably from 2 hrs to 5 hrs, suitably from 2 hrs to 4 hrs, and suitably approximately 3 hrs and so forth.

The modifying agent may be any suitable modifying agent including, for example hydrogen peroxide (H₂O₂). Hydrogen peroxide may be provided as an aqueous solution, and suitably a solution having hydrogen peroxide concentration in the range of 20 to 50 wt %, and more suitably at a concentration in the range of 25 to 45 wt %, and even more suitably in a concentration range of 30 to 40 wt %. Suitably the modifying agent is a hydrogen peroxide solution at a mass concentration in the range of 30 to 35 wt %.

Examples of other possible modifying agents include peracetic acid, benzoyl peroxide, sodium perborate, ammonium hydroxide, or alkali hydroxides such as sodium hydroxide and potassium hydroxide. In one example, the modify agent may include hydrogen peroxide in combination with any one of peracetic acid, benzoyl peroxide, sodium perborate, ammonium hydroxide, or alkali hydroxides such as sodium hydroxide and potassium hydroxide.

In one example, adding the modifying agent to the feed suspension is performed disjunctively, in which the mixing step is carried out after the modifying agent has been added to the composition.

In another example, at least part of the modifying agent may be added to feed suspension whilst the mixing is carried out.

The method may include heating the composition during at least part of the mixing step. The method may also include controlling the temperature of the composition based on a predetermined period of the mixing.

The mixing step may include heating the composition to a temperature in the range of, for example, from 50° C. to about 200° C., or preferably about 80° C. to about 150° C., or preferably in the range of 50 to 98° C., and ideally in the range of 80 to 90° C.

The method may also include a step of cooling the composition to stop the progress of the reaction of the modifying agent and the graphene oxide sheets. The cooling step may include reducing the temperature of the composition to below 50° C. In one example, the cooling step may include reducing the temperature of the composition to a temperature below 45° C. In another example, the cooling step may include reducing the temperature of the composition to a temperature in the range of the 15 to 45° C., and suitably to a temperature in the range of 25 to 45° C.

The mixing step may also be carried out under increased pressure conditions. For example, under evaporation of solvent, additive agent, or by way of gas production such as carbon dioxide, or carbon monoxide. The increased pressure may be an elevated pressure in the range of 5 to 15 bar (absolute). Suitably, the increased pressure of the mixing step may be a pressure in the range of 7.5 to 12 bar (absolute).

The mixing step may be carried out in any suitable vessel for heating and mixing the composition. The vessel may also be closed such as, for example, an autoclave. The autoclave enables the mixing/agitation, heating and pressurisation to be carried out in a single vessel simultaneously.

There are a number of parameters that can be used for measuring when the reaction between the modifying agent and the graphene oxide sheets has progressed far enough so the temperature of the composition can be reduced to stabilise the composition. For example, carbon dioxide may be released by the reaction of the modifying step, and the amount of carbon dioxide produced may be a measure of the extent of the reaction of the modifying agent with graphene oxide sheets. Other parameters or characteristics that can be measured include any one or a combination of (i) viscosity of the composition, (ii) colour and colour changes of the composition, and (iii) infrared spectrum analysis of the composition. Viscosity may be measured, for example, by taking an aliquot and analysing the sample. In another example, viscosity may be measured as a function of the power required to mix the composition by a mixer. For instance, a measure of the power consumed by an electromagnetic mixer or the power consumed by an electrical motor may be a function of the viscosity of the composition, and in turn, the extent of the reaction of the modifying agent with the graphene oxide sheets.

Generally speaking, we have found that viscosity initially increases during the reaction between the modifying agent and the graphene oxide sheets, and then decreases, indicating that the reaction has progressed far enough to be stopped. Moreover, we have found that the viscosity increases and then decreases back to a viscosity approximate to the original viscosity at the start of the mixing step.

The method may include measuring the viscosity of the composition to determine when to stop the progress of the reaction.

The reaction may be stopped by reducing the temperature of the composition when the viscosity is within 15% of a maximum viscosity, suitably within 10% of the maximum viscosity, more suitably within 5% of the maximum viscosity, and even more suitably within 1 to 5% of the maximum viscosity of the composition.

The reaction may be stopped by reducing the temperature of the composition when the viscosity reaches a maximum or has started reducing from a maximum viscosity.

In addition, the reaction has also progressed far enough when reducing the temperature of the composition forms a stable composition and the composition can be applied to a substrate to form the filtration membrane.

Once the modifying agent has reacted with the graphene oxide, for example, after a predetermined period has lapsed, the composition may be cooled. In the event of any pressure build up, the pressure may also be released.

One of the purposes of the modifying agent is to increase the number of pores or holes in the graphene oxide sheets. The modifying agent will react with the graphene oxide sheets to introduce new holes or further increase existing holes to provide a distribution of different sizes of nanopores. The nanopores can have pores having a maximum diameter from 1 nm, from 2 nm, from 3 nm, 4 nm, 5 nm, up to 10 nm, up to 20 nm, up to 50 nm, up to 100 nm or more.

### BRIEF DESCRIPTION OF THE DRAWING

Embodiments of the present invention will now be described with reference to the accompanying Figures which may be summarised as follows.

FIG. 1 is a block diagram of the steps of preparing a graphene oxide composition and a filter including a substrate and the composition for filtering fluids according to a preferred embodiment.

FIG. 2 is a block diagram of the steps of preparing a graphene oxide composition and a filter including a substrate and the composition for filtering fluids according to another embodiment.

FIG. 3 is a block diagram of the steps of selecting a suitable graphene oxide suspension and making a filter including a substrate and the suspension for filtering fluids according to another embodiment.

FIG. 4 is a block diagram of the steps of preparing a graphene oxide suspension and the making a filter including a substrate and a composition include the suspension according to another embodiment.

FIG. 5 is a schematic cross-sectional view of the filter according to an embodiment that can be made in accordance with the steps outlined in FIGS. 1 to 4.

### DESCRIPTION OF THE DRAWINGS

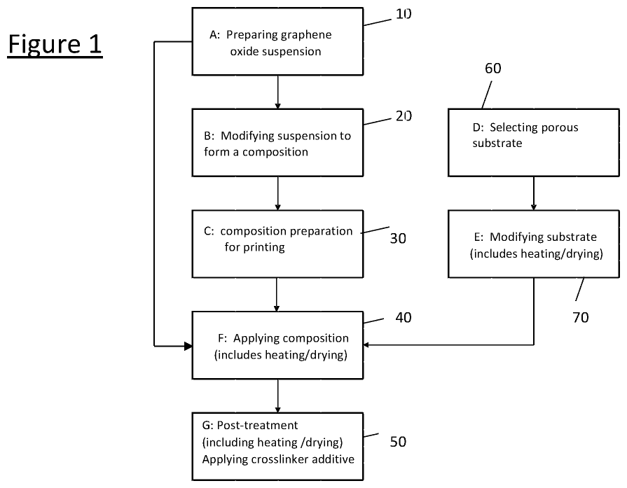

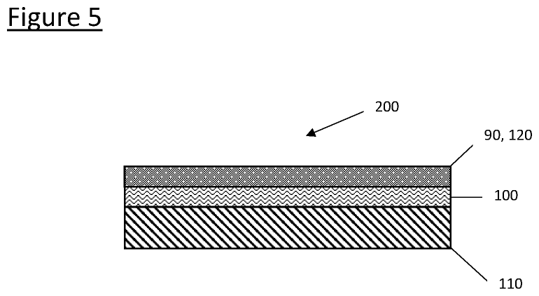

FIG. 1 is a block diagram of an embodiment for making a filter 200 (shown in FIG. 5) including the graphene oxide filtration membrane 90. FIG. 1 has steps that include modifying the substrate 110 in step 70 by applying an adhesive agent 100 to a substrate 110 to assist in adhering/bonding a graphene oxide filtration membrane 90 to the substrate 110, and applying a crosslinking additive 120 to the dried graphene oxide filtration membrane 90 in a post treatment step 50. The crosslinking additive 120 provides a level of chlorine resistance to the graphene oxide filtration membrane 90. The suitability of a graphene oxide feed suspension that can be included in a composition that can be printed or applied to form a graphene oxide filtration membrane 90 on the substrate 110 is a function of many variables. One possible variable is the level or concentration of impurities in the feed suspension. Step 10 of FIG. 1 can including selecting a graphene oxide suspension, and depending on the known properties of the suspension, step 10 can include the optional steps of assessing the level of impurities in the feed suspension and one method for doing so is measuring the electrical conductively of the feed suspension. Step 10 of FIG. 1 may also include an optional step of combining dry graphite oxide with water and mixing, or combining dry graphene oxide with water and mixing. For example, a feed suspension may be prepared by combining a graphene oxide cake containing 43±5 wt % graphene oxide with water and mixing. Water may be added to the feed suspension to adjust the graphene oxide concentration into a range from 0.1 to 15 wt %.

Step 20 of FIG. 1 is optional can include treating or modifying the feed suspension to create imperfections in the graphene oxide. Specifically, Step 20 includes adding an active modifying agent to the feed suspension to form a composition, and mixing the composition under elevated temperature and then reducing the temperature of the composition to stop progress of the reaction between the modifying agent and the graphene oxide so that the composition becomes stable. In this situation all of, or nearly all of, the modifying agent may have reacted with the graphene oxide sheets. Step 20 can include determining the amount of modifying agent(s) to be added to the feed suspension, including determining a desired mass ratio of modifying agent to the graphene oxide sheets in the feed suspension. In addition, Step 20 can be carried out under heated conditions, which may or may not be accompanied by pressurised conditions, to increase the reaction rate between the modifying agent(s) and the graphene oxide. The period of mixing the composition may be reduced by increasing the temperature and pressure conditions of Step 20. Conversely the period of mixing the composition may be increased by lowering the temperature to ambient temperature.

In a situation in which the modifying agent comprises hydrogen peroxide in isolation with no other modifying agent, we have found that a 30 wt % hydrogen peroxide solution can be added to the feed suspension at a ratio of equal to or less than 5 parts hydrogen peroxide to 1 part feed suspension. In this embodiment the suspension comprises approximately 1 mg/ml of graphene oxide. When used in this range, the hydrogen peroxide is reacted with the graphene oxide for a sufficient reaction period. These conditions provide a graphene oxide with the required permeance, avoids subsequent separation of excess modifying agent from the feed suspension, and can be readily scaled up into commercial operating batches. Step 20 may be carried out in a batch operation.

Step 20 of FIG. 1 may include determining when the reaction between the modifying agent and the graphene oxide has progressed far enough by measuring, for example, any one or a combination of the viscosity of the composition, colour and colour changes of the composition, and infrared spectrum analysis of the composition. The reaction between the modifying agent and the graphene oxide may also produce a gas, such as carbon dioxide, and determining whether the reaction has progressed far enough may be determined by measuring the amount of the gas produced during the mixing step.

The composition may then be treated in Step 30 of FIG. 1 to facilitate the composition being printed by a microgravure printing machine or other application methods. Properties of the composition, such as viscosity and surface tension may then be measured and adjusted in Step 30 to make the composition suitable for printing. For example, the surface tension may be controlled using surfactants such as Triton™ available from DOW Inc. In another example, the viscosity of the composition may also be controlled by adding polyphenol and/or ethanol. Adjusting the viscosity and/or the surface tension enables the composition to be applied as a filtration membrane using high speed printing machinery, such as gravure printing or microgravure printing. In other words, not only is the composition suitable for making filtration membranes, but in addition, the composition can be applied at a manufacturing speed at a large scale.

One of the benefits of the method shown in FIG. 1 is that no crosslinking materials need to be added to the composition prior to applying the composition to the substrate.

Step 60 of FIG. 1 can include selecting the porous substrate 110 such as a porous film including polymeric, metallic or ceramic films. Selecting an appropriate substrate 110, is typically based on the desired permeance and flexibility.

Step 70 of FIG. 1 can include modifying the substrate 110 to improve the adhesion of the graphene oxide membrane 90 to the porous substrate. For example, the adhesive additive 100, such as either one or a combination of, adhesives such as polyDADMAC and GOHSENX™K can be applied to the substrate in Step 70, and dried. The rate at which the adhesive additive 100 dries may be increased by heating once the adhesive additive 100 has been applied to the substrate 110. The adhesive additive 100 may be applied using dip coating, printing, spraying, or other suitable techniques.

Step 40 of FIG. 1 can include printing or applying the composition prepared in Step 30 to the substrate 110 to form the filtration membrane 90. This may be done by a gravure printing machine such as a micro-gravure printing machine, or other techniques such as dip coating, rod coating, knife coating, blade coating, vacuum filtration or spraying to form a membrane of the composition on the substrate. Step 40 may include drying the composition which may be done in ambient conditions. However ideally, the rate at which the composition dries may be increased by exposure to radiant heat or by convection, for example, by means of a stream of heated air. The adhesion of the composition to the substrate is less prone to degradation as a result of the adhesive additive applied in Step 70.

Step 50 of FIG. 1 can include a post treatment of the filtration membrane by applying a crosslinking additive 120 to the dried graphene oxide membrane 90. The crosslinking additive 120 may include a cationic polymer, suitably having quaternary ammonium functionality such as polyDADMAC, or epoxide based crosslinking additive, such as GLYMO. The crosslinking additive 120 provides a level of chlorine resistance and pH resistance to the graphene oxide membrane. The term “pH resistance” refers to the rejection of the filtration membrane being less variable over a broader pH range than if no crosslinking additive 120 was added to the composition. The term “chlorine resistance” refers to the resistance of the membrane to degradation caused by sodium hypochlorite, or other hypochlorite salt.

Step 50 of FIG. 1 can also include a permeance-enhancing or permeance setting step by exposing the membrane 90 to a solution of sodium hypochlorite for a period of time. For example, the membrane 90 can be submerged in a 10 g/L solution of sodium hypochlorite for a period of 30 minutes (5,000 ppm·h) to increase the permeance.

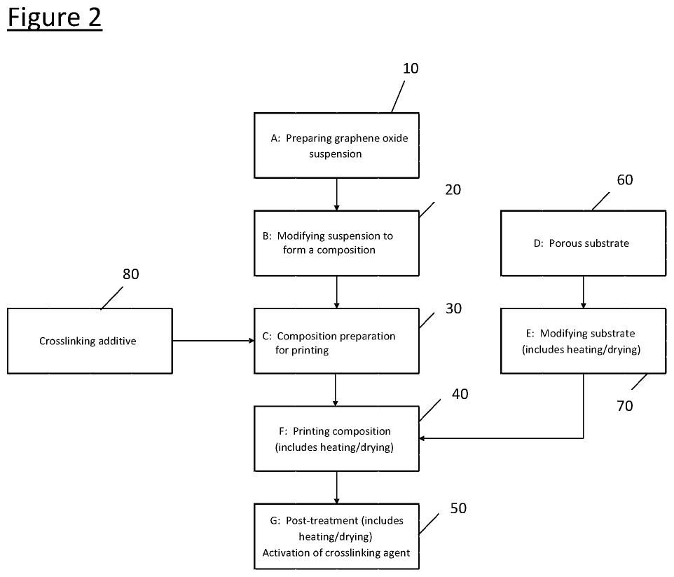

FIG. 2 is a block diagram of an embodiment for making a filter 200 including the graphene oxide filtration membrane 90. The embodiment includes modifying a substrate 110 in step 70 by applying an adhesive additive 100 to a substrate 110 to assist in adhering a graphene oxide filtration membrane 90 to the substrate 110, and adding a crosslinker additive 120 to a composition containing the graphene oxide prior to the composition being applied to the substrate 110, and optionally activating of the crosslinker 120 in a post-treatment step after the composition has been applied to the substrate to provide chlorine resistance, and some pH resistance. Step 10 of FIG. 2 can include the same procedures described above in relation to Step 10 of FIG. 1. Ideally, the feed suspension has or is adjusted to have a graphene oxide concentration into a range of 0.1 to 15 wt %.

Step 20 of FIG. 2 can include the same procedures described above in relation to Step 20 of FIG. 1. That is Step 20 includes treating the feed suspension to create imperfections in the graphene oxide and form a composition. Step 20 can include adding an active modifying agent to the feed suspension to form the composition, and mixing the composition under elevated temperature and then reducing the temperature of the composition to stop progress of the reaction between the modifying agent and the graphene oxide to stabilise the composition. In this situation all of, or nearly all of, the modifying agent may have reacted with the graphene oxide. In addition, Step 20 of FIG. 2 can include determining whether the reaction can be stopped to form a stable composition.

For instance, Step 20 of FIG. 2 may include determining when the reaction between the modifying agent and the graphene oxide has progressed far enough by measuring, for example, any one or a combination of the viscosity of the composition, colour and colour changes of the composition, and infrared spectrum analysis of the composition. The reaction between the modifying agent and the graphene oxide may also produce a gas, such as carbon dioxide, and determining whether the reaction has progressed far enough may be determined by measuring the amount of the gas produced during the mixing step.

The composition may then be treated in Step 30 of FIG. 2 to facilitate the composition being printed using gravure printing machines such as microgravure printing machines, or other application methods. For instance, viscosity and surface tension may then be measured and adjusted in Step 30 by adding surfactants such as Triton™ available from DOW Inc. The viscosity of the composition may also be controlled by adding polyphenol and/or ethanol. Adjusting the viscosity and/or the surface tension enables the composition to be applied as a filtration membrane using high speed printing machinery, such as gravure printing including microgravure printing.

In addition, Step 30 of FIG. 2 can include step 80 of adding a crosslinking additive 120 to the composition such as either one or a combination of epoxide containing crosslinkers, such as GLYMO or GTAC (glycidyl trimethylammonium chloride). These crosslinking additive 120 provide stabilization to the rejection properties of the filtration membrane over a broader range of pH than if no crosslinking additive was included. At a structural level the crosslinkers manage the spatial separation between the graphene oxide sheets.

Step 60 of FIG. 2 can include the same procedures described above in relation to Step 60 of FIG. 1. Specifically, Step 60 can include selecting a porous substrate 110 such as a porous film including polymeric, metallic or ceramic films.

Step 70 of FIG. 2 can include modifying the substrate 110 to improve the adhesion of the graphene oxide membrane 90 to the porous substrate 110. For example, an adhesive additive 100, such as either one or a combination of, polymers such as polyDADMAC and GOHSENX™K can be applied to the substrate in Step E, and dried. The rate at which the adhesive additive 100 dries may be increased by heating once the adhesive additive 100 has been applied to the substrate 110. The adhesive additive 100 may be applied using dip coating, printing, spraying, or other suitable techniques.

Step 40 of FIG. 2 can include the same steps as Step 40 described in relation to FIG. 1. For instance, Step 40 of FIG. 2 can include printing or applying the composition prepared in Step 30 to the substrate 110 to form a graphene oxide membrane 90 provided by the composition. This may be done by a gravure printing machine such as a microgravure printing machine, or other techniques such as dip coating or spraying to form a membrane of the composition on the substrate. Step F may include drying the composition which may be done in ambient conditions.

Step 50 of FIG. 2 can include a post treatment step in which a crosslinking additive including a cationic polymer, suitably having quaternary ammonium functionality, or epoxide based crosslinking additive, such as GLYMO. Step 30 may include activating the crosslinking additive 120 to complete the crosslinking between the graphene oxide sheets. In one example, activation can be carried out by heating the substrate and composition on the substrate above 50° C. for at least 1 hour, and suitably to a temperature of 75° C. for at least 2 hours. In another example, a catalyst such as aluminium acetylacetonate (1 g/L in 2-propanol) can be applied to the graphene oxide membrane by dip-coating, gravure printing, microgravure printing, or rod coating. For dip-coating, a coupon of the graphene oxide membrane 120 was submerged in a bath of the catalyst solution for a period of 5 minutes, after which the coupon was removed from the bath and dried at ambient temperature without washing. Step 50 of FIG. 2 can also include a permeance-enhancing step of exposing the membrane 90 to a solution of sodium hypochlorite for a period of time. For example, the membrane 90 can be submerged in a 10 g/L solution of sodium hypochlorite for a period of 30 minutes (5,000 ppm·h) to increase the permeance.

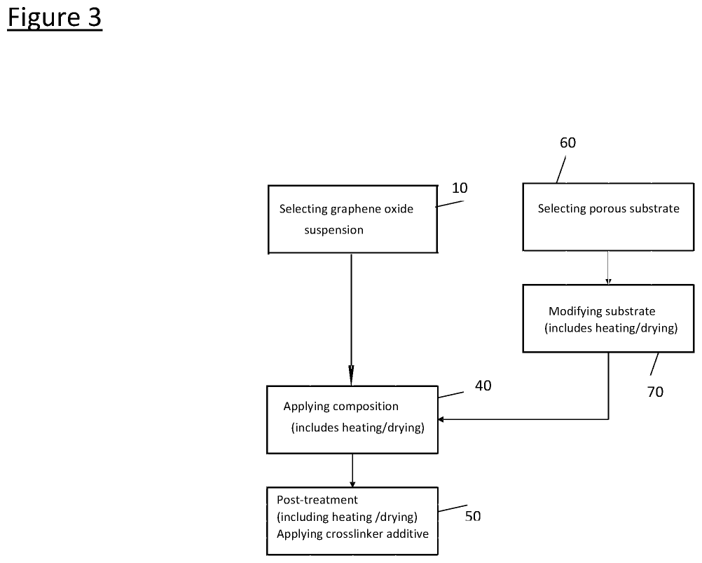

FIG. 3 is a block diagram of an embodiment for making a filter 200 including the graphene oxide filtration membrane 90. The embodiment includes selecting a composition that can be applied to, including printed on, a substrate 110 to form the graphene oxide filtration membrane 90. FIG. 3 has particular steps that include modifying the substrate in step 70 by applying an adhesive additive 100 to a substrate 110 to assist in adhering the graphene oxide filtration membrane 90 to the substrate 110, and applying a crosslinking additive 120 to the dried graphene oxide filtration membrane 90 in a post treatment step 50. The crosslinking additive 120 provides a level of chlorine resistance to the graphene oxide filtration membrane. Similarly, the adhesive additive 100 also has chlorine resistance.

Step 10 of FIG. 3 includes selecting a graphene oxide suspension for use as composition to form a graphene oxide filter membrane 90. Depending on the known properties of the graphene oxide suspension, Step 10 may optionally also include adjusting the concentration of the graphene oxide to a range from 0.1 to 15 wt %, and optionally adjusting the viscosity and surface tension of the suspension. Step 10 of FIG. 3 does not include treatment of the graphene oxide sheet with the oxidising agent which occurs in Step 20 of FIGS. 1 and 2.

Step 60 of FIG. 3 can include the same procedures described above in relation to Step 60 of FIG. 1. Specifically, Step 60 can include selecting a porous substrate 110 such as a porous film including polymeric, metallic or ceramic films.

Step 70 of FIG. 3 includes modifying the substrate 110 to improve the adhesion of the graphene oxide membrane 90 to the substrate 110. For example, an adhesive additive 100, such as either one or a combination of, polyDADMAC and GOHSENX™K can be applied to the substrate 110 in Step 70, and dried. The rate at which the adhesive additive 100 dries may be increased by heating once the adhesive additive 100 has been applied to the substrate 110. The adhesive additive 100 may be applied using dip coating, printing, spraying, or other suitable techniques.

Step 40 of FIG. 3 includes applying, including printing, the composition prepared in Step 30 to the substrate 110 to form a graphene oxide membrane 90. This may be done by a gravure printing machine such as a microgravure printing machine, or other techniques such as dip coating or spraying so as to form a membrane of the composition on the substrate. Step F may include drying the composition which may be done in ambient conditions or by using heating or ventilation means.

Step 50 of FIG. 3 includes an optional step of treating the graphene oxide membrane 90, suitably after the graphene oxide membrane 90 has been dried, and hence it may be referred to a post-treatment step. The post treatment step may include applying a crosslinking additive 120 including a cationic polymer, suitably having quaternary ammonium functionality, or epoxide based crosslinking additive, such as GLYMO. Step 30 may include activating the crosslinking additive 120 to complete crosslinking between the graphene oxide sheets. Optionally, Step 50 may also include element of Step 50 in FIGS. 1 and 2.

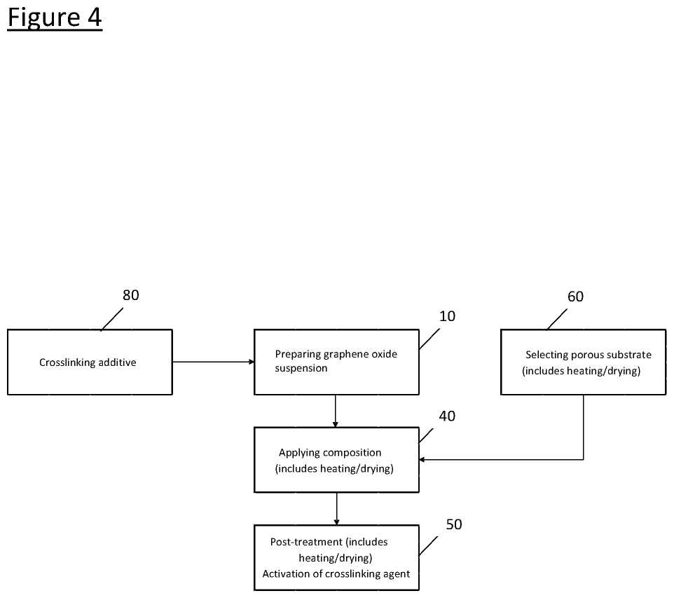

FIG. 4 is a block diagram of the steps of preparing a graphene oxide suspension and the making a filter 200 including a substrate 110 and a composition include the suspension. Step 10 of FIG. 1 can including selecting a graphene oxide suspension, and depending on the known properties of the suspension, step 10 can include the optional steps preparing a suitable feed suspension by assessing the level of impurities in the feed suspension by measuring the electrical conductively of the feed suspension. Step 10 of FIG. 1 may also include an optional step of preparing a suitable feed suspension by combining dry graphite oxide with water and mixing. Water may be added to the feed suspension to adjust the graphene oxide concentration into a range from 0.1 to 15 wt %. FIG. 4 includes Step 80 of adding crosslinking additives to the suspension such as either one or a combination of epoxide containing crosslinkers, such as GLYMO or GTAC (glycidyl trimethylammonium chloride) to form a composition. These crosslinking additives provide stabilization to the rejection properties of the filtration membrane over a broader range of pH than if no crosslinking additive was included.

Step 60 of FIG. 4 can include the same procedures described above in relation to Step 60 of FIG. 1. Specifically, Step 60 can include selecting a porous substrate 110 such as a porous film including polymeric, metallic or ceramic films. Although not shown, FIG. 4 may include the optional step of modifying the substrate 110 to improve the adhesion of the graphene oxide to the porous substrate. For example, an adhesive additive 100, such as either one or a combination of, adhesives such as polyDADMAC and GOHSENX™K can be applied to the substrate in Step 70, and dried.

Step 40 of FIG. 4 includes printing or applying the composition to the substrate 110 to provide a graphene oxide membrane 90. This may be done by a gravure printing machine such as a microgravure printing machine, or other techniques such as dip coating or spraying to form a membrane of the composition on the substrate. Step 50 may include drying the composition which may be done in ambient conditions or by using heating or ventilation means.

Step 50 of FIG. 4 includes an optional step of treating the graphene oxide membrane 90, suitably after the graphene oxide membrane 90 has been dried, and hence it may be referred to a post-treatment step. The post treatment step may include applying a crosslinking additive 120 including a cationic polymer, suitably having quaternary ammonium functionality, or epoxide based crosslinking additive, such as GLYMO. Step 30 may include activating the crosslinking additive 120 to complete crosslinking between the graphene oxide sheets. Optionally, Step 50 may also include element of Step 50 in FIGS. 1 and 2

FIG. 5 is a schematic cross-section view of the filter including a graphene oxide membrane 90 applied to a substrate 110. The substrate 110 can be selected in accordance with Step 60 and optionally modified in accordance with Steps 70 by applying an adhesive additive 100. The graphene oxide membrane 90 that is applied to the substrate 110 includes the suspension or composition of Step 10, and the composition may optionally be further characterised by the Steps 20 and 30. The composition applied to the substrate may include a crosslinking additive 120 which is suitably applied to a dried graphene oxide membrane 90 formed on the substrate 110 in accordance Step 50. Optionally, crosslinking additive 120 may also be added to the composition containing the graphene oxide prior to the composition being applied to the substrate 110, such as in Steps 30 and 80.

### Examples

### Example 1

In this example, a composition and a filtration membrane were made in accordance with the Steps of FIG. 1. The permeance and the rejection of this filtration membrane were measured, in accordance with the membrane performance test described below, to be 14 L/m²/h/bar and 96% respectively. These measurements are included in Table 3A.

A composition containing modified graphene oxide (8.6 g/L), i.e., the GO composition was prepared by reacting graphene oxide (10 g/L) with hydrogen peroxide (5:1 mass ratio H₂O₂:GO) for 6.0 h at 90° C. in an autoclave.

A porous substrate membrane, which was commercially available under the trade name Solecta PVDF 400, was prepared by printing a thin film of GOHSENX™K onto the substrate using a microgravure printer to act as an adhesive additive. GOHSENX™K was in the form of a 50% aqueous ethanol (4.3 g/L) solution. After drying, a thin film of the modified GO composition was applied to the treated porous membrane support using a microgravure printer at a density of approximately 0.1 g/m². The modified GO composition contained 4.3 g/L of modified graphene oxide. After drying, a thin film of crosslinking additive comprising polyDADMAC (average M_{w}<100,000, Sigma-Aldrich product code 522376) was applied at a density of approximately 0.01 g/m² to the graphene oxide membrane using a microgravure printer, from a 50% aqueous ethanol solution containing 5 g/L polyDADMAC.

### Example 2

In this example, a composition and a filtration membrane were made in accordance with the Steps of FIG. 2. The permeance and the rejection of this filtration membrane were measured, in accordance with the membrane performance test described below, to be 27 L/m²/h/bar and 95% respectively. These measurements are included in Table 3A.

A composition containing modified graphene oxide (8.6 g/L) was prepared by reacting graphene oxide (10 g/L) with hydrogen peroxide (5:1 mass ratio H₂O₂:GO) for 6.0 h at 90° C. in an autoclave. 100 ml of the modified graphene oxide suspension was diluted to 5 g/L by adding 70 mL of 2-propanol. 0.43 g of glymo, (3-glycidyloxypropyl)trimethoxysilane, was added to the diluted suspension (dropwise), while the suspension was being vigorously stirred.

A porous membrane substrate was prepared by printing a thin film of an adhesive additive comprising GOHSENX™K onto a substrate at a density of approximately 0.1 g/m². The substrate comprised Solecta PVDF 400 and an aqueous solution of GOHSENX™K (5 g/L) was applied using a microgravure printer. After drying, a thin film of the modified graphene oxide composition was applied to the treated porous membrane substrate using a microgravure printer at a density of approximately 0.09 g/m². After drying, the membrane was immersed in a solution of aluminium acetylacetonate (1 g/L in 2-propanol) for 5 minutes which acts as a catalyst for the glymo to form crosslinks between the graphene sheets. The membrane was then removed from the catalyst solution and dried at ambient temperature without washing.

### Example 3

In this example, a composition and a filtration membrane were made in accordance with the Steps of FIG. 1.

A graphene oxide membrane can also be formed on a hollow fibre porous support, such as an ultrafiltration or microfiltration hollow fibre made of polyvinylidene fluoride, polypropylene, polyacrylonitrile, polysulphone, or ceramic.

The fibre is dipped in an adhesive additive comprising GOHSENX™K (4 g/L in 50% aqueous ethanol) for 1 minute, then dried for 1 hour in a dehydrator at 70° C. (application of adhesive).

A composition containing modified graphene oxide (8.6 g/L) was prepared by reacting graphene oxide (10 g/L) with hydrogen peroxide (5:1 mass ratio H₂O₂:GO) for 5.5 h at 90° C. in an autoclave, then diluting to 1 g/L graphene oxide with water. The adhesive-coated substrate was then submerged in the composition and connected to a vacuum pump. A vacuum is applied to the adhesive-coated membrane until the permeate is colourless, indicating that a graphene oxide film had formed on the fibre substrate, preventing further passage of graphene oxide. The graphene oxide-coated fibre was then dried overnight at 70° C. in a dehydrator.

A crosslinking additive was then applied to the film of graphene oxide by being dipped in a solution of polyDADMAC (5 g/L in 50% aqueous ethanol) for 1 minute, then dried for 2 hours in a dehydrator at 70° C.

The treated hollow fibre was then submerged in a solution of Rose Bengal (˜200 mg/L) and a vacuum applied. The area of the fibre was unknown so the permeance could not be calculated, but the concentration of the feed and permeate showed that the rejection was 99%.

### Filtration Membrane Performance Testing

We have tested the permeance and rejection of the filtration membranes mentioned in Examples 1 and 2 above, and several other samples of filtration membranes that have been made in accordance with the embodiments shown in FIGS. 1 and 2. Results of the tests are summarised in Tables 3A, 3B, 3C and 3D.

The testing procedure included flat samples of the filtration membranes being held in a cross-flow mode at 2 bar transmembrane pressure using Rose Bengal (4,5,6,7-tetrachloro-2′,4′,5′,7′-tetraiodofluorescein disodium salt) as the probe molecule (200-300 mg/L) at pH 9 (unless otherwise specified) using a Sterlitech CF042 cell. The membrane area was 42.1 cm². Rejection was calculated from the concentration of Rose Bengal in the feed and the permeate according to the following equation:

$$\begin{matrix}Rejection = [ 1 - ( {RB}_{p e r m e a t e} / {RB}_{feed} ) ] \times 100 \% \\ Where : \\ {RB}_{feed} = concentration of Rose Bengal in the feed \\ {RB}_{p e r m e a t e} = concentration of Rose Bengal in the permeate\end{matrix}$$

The concentration of Rose Bengal was measured by UV-visible spectrophotometry, using the Beer-Lambert Law to convert the absorbance at 549 nm to concentration in mg/L.

The flow rates of the feed and the permeate were measured gravimetrically for calculation of the permeance using the following equation:

$$\begin{matrix}Permeance ( L / {m}^{2} / h / bar ) = {V}_{p e r m e a t e} / ( A \times t \times P ) \\ Where : \\ V = volume of permeate ( L ) \\ A = area of membrane ( {m}^{2} ) \\ t = time ( h ) during which permeate was collected \\ P = transmembrane pressure ( bar )\end{matrix}$$

NaOCl post-treatment was carried out by exposing membrane coupons to a 10000 mg/L solution of NaOCl for 30 minutes.

Chlorine resistance was evaluated by exposing membrane coupons to a solution of NaOCl at the specified pH for a period of time. For example, 10,000 ppm™h=1 hour of exposure to a 10000 mg/L NaOCl solution. Following chlorine exposure, the membrane coupon was rinsed with deionised water and then tested using Rose Bengal as above.

TABLE 3A
Rejection of Rose Bengal with various combinations of adhesive and crosslinker

| | | | | | | Made in |
|---|---|---|---|---|---|---|
| | | Adhesive additive | Crosslinking | Permeance | Rejection | accordance |
| Sample | Substrate | added to substrate | additive | L/m²/h/bar | % | with: |
| 1a | Solecta | GOHSENX-K | polyDADMAC | 14 | 96% | FIG. 1 |
| | PVDF400 | | | | | |
| 2a | Solecta | GOHSENX-K | glymo | 27 | 95% | FIG. 2 |
| | PVDF400 | | | | | |
| 3a | Solecta | polyDADMAC | glymo | 23 | 99% | FIG. 2 |
| | PVDF400 | | | | | |
| 4a | Solecta | polyDADMAC | GOHSENX-K | 34 | 98% | FIG. 1 |
| | PVDF400 | | | | | |
| 5a | Synder Bx | GOHSENX-K | polyDADMAC | 12 | 99% | FIG. 1 |

The measurements in Table 3A shows that the filtration membranes made in accordance with FIGS. 1 and 2 with combinations of adhesive and crosslinking additives have viable rejections of equal to, or greater than 90%, and in the range from 96% to 99%. In addition, the permeance is measured to range from 12 to 34 L/m²/h/bar.

TABLE 3B
Improved permeance after NaOCl post-treatment and maintaining high rejection

| | | | | | | | Made in |
|---|---|---|---|---|---|---|---|
| | | Adhesive additive | Crosslinking | Post- | Permeance | Rejection | accordance |
| Sample | Substrate | added to substrate | additive | treatment | L/m2/h/bar | % | with |
| 7a | Solecta | GOHSENX-K | glymo | None | 27 | 95% | FIG. 2 |
| | PVDF400 | | | | | | |
| 7b | Solecta | GOHSENX-K | glymo | NaOCl | 37 | 99% | FIG. 2 |
| | PVDF400 | | | | | | |
| 8a | Solecta | GOHSENX-K | polyDADMAC | None | 14 | 96% | FIG. 1 |
| | PVDF400 | | | | | | |
| 8b | Solecta | GOHSENX-K | polyDADMAC | NaOCl | 31 | 94% | FIG. 1 |
| | PVDF400 | | | | | | |
| 9a | Solecta | polyDADMAC | glymo | None | 14 | 98% | FIG. 2 |
| | PVDF400 | | | | | | |
| 9b | Solecta | polyDADMAC | glymo | NaOCl | 20 | 94% | FIG. 2 |
| | PVDF400 | | | | | | |
| 10a | Synder Bx | GOHSENX-K | polyDADMAC | None | 12 | 99% | FIG. 1 |
| 10b | Synder Bx | GOHSENX-K | polyDADMAC | NaOCl | 35 | 93% | FIG. 1 |

Table 3B includes measurements that compare the filtration membranes without a post treatment and filtration membranes that include a bleach post treatment. The combinations of substrate, adhesive additive and crosslinking additive show that the filtration membranes were resistant to the chlorine in the bleach post treatment, whilst maintaining viable rejection rates of greater than 90%. In addition, the bleach post treatment was shown to increase the permeance of the filtration membranes.

TABLE 3C
Stable rejection and permeance after exposure to bleaching solution

| | | | | | Exposure | | | Made in |
|---|---|---|---|---|---|---|---|---|
| | Porous | Adhesive | Crosslinking | | to NaOCl | Permeance | Rejection | accordance |
| Sample | Substrate | additive | additive | pH | ppm · h | L/m2/h/bar | % | with |
| 13a | Solecta | GOHSENX-K | polyDADMAC | 5.5 | 0 | 12 | 97% | FIG. 1 |
| 13b | PVDF400 | | | | 10000 | 14 | 96% | FIG. 1 |
| 13c | | | | | 20000 | 17 | 95% | FIG. 1 |
| 13d | | | | | 50000 | 14 | 93% | FIG. 1 |
| 13e | | | | | 100000 | 26 | 91% | FIG. 1 |
| 14a | | | | 12 | 0 | 12 | 97% | FIG. 1 |
| 14b | | | | | 10000 | 20 | 96% | FIG. 1 |
| 14c | | | | | 20000 | 40 | 93% | FIG. 1 |
| 14d | | | | | 50000 | 26 | 95% | FIG. 1 |
| 14e | | | | | 120000 | 52 | 88% | FIG. 1 |
| 15a | | polyDADMAC | glymo | 5.5 | 0 | 23 | 96% | FIG. 2 |
| 15b | | | | | 25000 | 26 | 96% | FIG. 2 |
| 15c | | | | | 50000 | 28 | 94% | FIG. 2 |
| 15d | | | | | 75000 | 31 | 94% | FIG. 2 |
| 15e | | | | | 100000 | 32 | 94% | FIG. 2 |
| 16a | | | | 12 | 0 | 24 | 97% | FIG. 2 |
| 16b | | | | | 25000 | 29 | 94% | FIG. 2 |
| 16c | | | | | 50000 | 33 | 90% | FIG. 2 |
| 16d | | | | | 75000 | 36 | 83% | FIG. 2 |
| 16e | | | | | 100000 | 42 | 78% | FIG. 2 |

Filter samples 13a to 16e were tested for chlorine resistance, by being submerged in a bleach solution at a pH of either 5.5 or 12, which represent typical acidic and alkaline conditions in which the filter may be washed. Samples 13a, 14a, 15a and 16a were used as control samples that were not exposed to bleach. The performance of the samples after being in contact with bleach was tested to determine permeance and rejection using Rose Bengal as the probe molecule as outlined above for test performance procedure. It will be appreciated that the test procedure may be conducted using other probe molecules and similar results can be achieved. For instance, probe molecules having similar molecular weights in the range of 100 or 200 or 300 or 400 to 1,000, or 2,000 or 3,000 or 4000 can be used.

The samples were submerged in the bleach solution comprising 10,000 mg/L of NaOCl for various periods. For exposures of 10,000 ppm·h, the samples were submerged for 1 hour, and similarly, for exposures of the 20,000 ppm·h, 50,000 ppm·h, 75,000 ppm·h and 100,000 ppm·h the samples were submerged for 2 hours, 5 hours, 7.5 hours and 10 hours respectively.

The results show for exposures of 100,000 ppm·h of NaOCl the samples retained acceptable filtering properties for Rose Bengal, or molecules of equivalent size. Generally speaking, for exposures of up to 100,000 ppm·h, rejections of equal to or greater than 78%, and suitably equal to or greater than 88%, or even more preferably equal to greater than 90% were measured. This represents an acceptable rejection of the probe molecules on the membrane.

In some examples, an acceptable rejection of at least 78% can be achieved on exposure to at least 100,000 ppm·h of chlorine, and in addition an increase in permanence, or preferably a doubling in permeance can also be achieved. For instance, with reference to the samples comprising polyDADMAC adhesive additive and glymo crosslinking additive, sample 15e had a permeance of 32 L/m2/h/bar and a rejection of 94% at a pH of 5.5. Sample 16c had a permeance of 33 L/m2/h/bar and a rejection of 90% at a pH of 12.

With reference to the samples 13a to 13e comprising GOHSENX-K adhesive additive and polyDADMAC crosslinking additive, sample 13e had a permeance of 26 L/m2/h/bar and a rejection of 91% at a pH of 5.5. Sample 14d was exposed to 50,000 ppm·h of NaOCl had a permeance of 26 L/m2/h/bar and a rejection of 95%.

The results show that the permeance of the filter may increase by equal to or less than 14 L/m2/h/bar when exposed to 100,000 ppm·h of NaOCl under acid conditions. For instance, from 12 to 26 L/m2/h/bar as in case of samples 13a to 13e.

The results show that the permeance of the filter may increase by equal to or less than 40 L/m2/h/bar when exposed to 100,000 ppm·h of NaOCl under alkaline conditions. For instance, from 12 to 52 L/m2/h/bar as in the case of samples 14a to 14e.

Table 4 includes samples 17 to 23 of membranes that were prepared in accordance with the procedure outlined in Example 1 and FIG. 1 and test for pH resistance. The membranes were prepared by coating a porous substrate comprising PVDF from TOMAC Corporation (Japan) with an adhesive additive comprising a GOHSENX™K aqueous solution. A thin film of the adhesive additive, at a density of approximately 0.1 g/m², was applied to the substrate using a microgravure printer and dried. A thin film of the graphene oxide composition was then applied at a density of approximately 0.09 g/m² using a microgravure printer. The membranes were then dip coated with aqueous solutions of various crosslinking additives as shown in Table 4 at a density of approximately 0.001 g/m², and the permeance and rejection of the membranes were tested under particular pH conditions. No crosslinking additive was added to sample 24 which provided a Control.

The membranes were tested for pH resistance in the cross-flow apparatus Sterlitech CF042, using a solution of Rose Bengal, at pH 4, pH 7 and pH 10. The permeance and the rejection were measured. The data set out in Table 4 shows that all of the cationic polymers tested as crosslinking additives produced membranes with higher rejection than the Control that had no crosslinking additive at each of the pH values. That is to say, the crosslinking additives had a pronounced effect on the ability of the membranes to continue to perform under various pH conditions, specifically from pHs values ranging from 4 to 10. The difference was most pronounced at pH 10, which is indicative of layers of the graphene oxide sheets swelling, which decreases rejection. The permeance increased as the rejection decreased.

TABLE 4
Stable performance of membranes including cationic polymers as crosslinkers

| | Crosslinking additive | | | | | | | | |
|---|---|---|---|---|---|---|---|---|---|
| | | | Conc | Permeance (L/m²/h/bar) | | | Rejection (%) | | |
| Sample | Trade name | Class/Description | (g/L) | pH 4 | pH 7 | pH 10 | pH 4 | pH 7 | pH 10 |
| 17 | SINOFLOC 680* | Cationic | 1 | 6.7 | 8.1 | 10.9 | 96.3% | 95.0% | 91.9% |
| | | polyacrylamide | | | | | | | |
| 18 | Polyquaternium-2* | Cationic poly urea- | 5 | 6.9 | 8.6 | 10.0 | 99.3% | 99.1% | 98.4% |
| | | ammonium-ether | | | | | | | |
| 19 | Hydroflux HB-2705* | Cationic | 1 | 9.0 | 10.4 | 12.9 | 98.6% | 97.9% | 95.8% |
| | | polyacrylamide | | | | | | | |
| 20 | Polyquaternium-10* | Cationic hydroxyethyl | 1 | 11.0 | 13.7 | 16.3 | 95.8% | 92.9% | 76.7% |
| | | cellulose | | | | | | | |
| 21 | Jaguar Optima* | Cationic guar | 1 | 11.6 | 16.1 | 19.8 | 91.9% | 86.4% | 65.5% |
| 22 | Polyquaternium-6* | Cationic polyDADMAC | 5 | 13.7 | 17.5 | 25.1 | 99.5% | 99.1% | 98.8% |
| 23 | PEI | Polyamine | 5 | 9.8 | 12.8 | 17.6 | 98.7% | 97.6% | 95.7% |
| 24 | N/A | Control | n/a- | 15.8 | 18.8 | 34.3 | 90.0% | 62.1% | 36.1% |

*indicates quaternary functionality

The membranes of the samples 17 to 23 were prepared in accordance with Example 1 and FIG. 1, and a Control, sample 24, was also tested for chlorine resistance. A First set of the samples 17 to 24 were treated with a solution of sodium hypochlorite (5 g/L) at pH 4 or at pH of 10 for 2 hours, that is 10,000 ppm·h of NaOCl. The membranes were then rinsed with deionised water to remove residual NaOCl, and then tested in the cross-flow apparatus using a solution of Rose Bengal, at pH 4 and pH 10. For comparison, another set of the membranes, namely the Second Set of samples 17 to 23 were made in accordance with Example 1 and FIG. 1, and Control 24 was prepared and tested without being exposed to chlorine, that is 0 ppm·h of NaOCl. The permeance and rejection of the Second Set of samples 17 to 24 were tested in the cross-flow apparatus using a solution of Rose Bengal at pH 4 and pH 10.

Table 5 comprises performance data of the First and Second Sets of samples 13 to 24 at a pH of 10. The data of the samples having a cationic polymer as crosslinking additive produced membranes with higher rejection than the Control which had no crosslinking additive after exposure to chlorine, such as sodium hypochlorite. The data also showed that the membranes having cationic polymers with quaternary ammonium groups as crosslinking additives produced membranes with improved resistance to degradation by chlorine. Specifically, the first set of samples 1 to 13 had permeance values after exposure to 10,000 ppm·h of NaOCl ranging from 13.7 to 29.8 (L/m²/h/bar) when measured using the probe molecule Rose Bengal in the cross-flow apparatus at a pH of approximately 10, ie under alkaline conditions. Under alkaline conditions, ie a pH of approximately 10, the rejection was greater than 90% with a cross linking additive selected from cationic polyacrylamide, Cationic poly urea-ammonium-ether, Cationic polyacrylamide, polyDADMAC. By comparison, the permeance of the second set of samples 13 to 30 which were not exposed to chlorine had a permeance values ranging from 10.9 to 25.1 (L/m²/h/bar). That is to say, the permeance, of the membranes, after exposure to 10,000 ppm·h of NaOCl increased in range from 2.8 to 5.3 (L/m²/h/bar) according to the Rose Bengal cross flow under alkaline conditions, whilst rejection ranged from 45.1% to 98.5%, and suitably 61.8% to 98.5%, and even more suitably from 90% to 98.5%.

TABLE 5
Chlorine resistance of membranes with quaternary ammonium crosslinkers at pH 10.

| | | | | Second Set of samples | | First Set of samples | |
|---|---|---|---|---|---|---|---|
| | | | | Filtration at pH 10 after | | Filtration at pH 10 after | |
| | Crosslinking additive | | | 0 ppm · h | | 10,000 ppm · h | |
| Sample | | | Conc | Permeance | Rejection | Permeance | Rejection |
| numbers | Trade name | Class/Description | (g/L) | (L/m²/h/bar) | % | (L/m²/h/bar) | % |
| 17 | SINOFLOC 680* | Cationic polyacrylamide | 1 | 10.9 | 91.9% | 13.7 | 90.7% |
| 18 | Polyquaternium-2* | Cationic poly urea- | 5 | 10.0 | 98.4% | 14.1 | 93.2% |
| | | ammonium-ether | | | | | |
| 19 | Hydroflux HB-2705* | Cationic polyacrylamide | 1 | 12.9 | 98.4% | 16.3 | 91.6% |
| 20 | Polyquaternium-10* | Cationic hydroxyethyl | 1 | 16.3 | 76.7% | 19.7 | 61.8% |
| | | cellulose | | | | | |
| 21 | Jaguar Optima* | Cationic guar | 1 | 19.8 | 65.5% | 25.1 | 45.1% |
| 22 | Polyquaternium-6* | Cationic polyDADMAC | 5 | 25.1 | 98.8% | 29.8 | 98.5% |
| 23 | PEI | Polyamine | 5 | 17.6 | 95.7% | 49.1 | 19.3% |
| 24 | None | Control | — | 34.3 | 36.1% | 51.3 | 20.5% |

*indicates quaternary functionality

In summary, when the crosslinking additive is a cationic polymer selected from cationic polyacrylamide, cationic poly urea-ammonium-ether, cationic hydroxyethyl cellulose, cationic guar and cationic polyDADMAC, and when exposed to 10,000 ppm·h of chlorine, the filter has rejection values ranging from 90% to 98.5% under alkaline conditions. In this instance, the filter has permeance values ranging from 13.7 to 29.8 (L/m²/h/bar) when measured using the probe molecule Rose Bengal in the cross-flow apparatus.

When the filter has a crosslinking additive including a cationic polymer and an adhesive additive including GOHSENX™K, and when exposed to 10,000 ppm·h of chlorine, the filter has a permeance value ranging from 13.7 to 29.8 L/m2/h/bar and a rejection value ranging from 90.7% to 98.5% under alkaline conditions.

Table 6 comprises performance data at pH of 4. The data of the samples having a cationic polymer as crosslinking additive produced membranes with higher rejection than the Control which had no crosslinking additive after exposure to chlorine, such as sodium hypochlorite. The data also showed that the membranes having cationic polymers with quaternary ammonium groups as crosslinking additives produced membranes with improved resistance to degradation by chlorine. Specifically the two far right columns shows permeance values after exposure to 10,000 ppm·h of NaOCl range from 11.0 to 23.8 (L/m2/h/bar) when measured using The probe molecule Rose Bengal in the cross-flow apparatus at a pH of approximately 4, ie under acidic conditions. By comparison, the permeance of the second set of samples 13 to 30, which was not exposed to chlorine had permeance values ranging from 10.9 to 25.1 (L/m²/h/bar). The permeance value of the membranes after exposure to 10,000 ppm·h of NaOCl increased by an amount of equal to or less than 10.1 (L/m²/h/bar), and suitably less than 5.0, and suitably by an amount in the range of 1.1 to 4.8 (L/m²/h/bar) according to the Rose Bengal cross flow under acid conditions and rejection values range from 86.9% to 99.2%, and suitably 90% to 99%, and even more suitably from 90% to 97%, and even more suitably still form 90% to 95%.

TABLE 6
Chlorine resistance of membranes with quaternary ammonium cationic crosslinkers at pH 4

| | | | | Second Set of samples | | First Set of samples | |
|---|---|---|---|---|---|---|---|
| | | | | Filtration at pH 4 after | | Filtration at pH 4 after | |
| | Crosslinking additive | | | 0 ppm · h | | 10,000 ppm · h | |
| Sample | | | Conc | Permeance | Rejection | Permeance | Rejection |
| number | Trade name | Class/Description | (g/L) | (L/m²/h/bar) | % | (L/m²/h/bar) | % |
| 17 | SINOFLOC 680* | Cationic polyacrylamide | 1 | 6.7 | 96.3% | 11.3 | 93.3% |
| 18 | Polyquaternium-2* | Cationic poly urea- | 5 | 6.9 | 99.3% | 11.0 | 95.0% |
| | | ammonium-ether | | | | | |
| 19 | Hydroflux HB-2705* | Cationic polyacrylamide | 1 | 9.0 | 98.6% | 13.8 | 93.9% |
| 20 | Polyquaternium-10* | Cationic hydroxyethyl | 1 | 11.0 | 95.8% | 12.1 | 90.9% |
| | | cellulose | | | | | |
| 21 | Jaguar Optima* | Cationic guar | 1 | 11.6 | 91.9% | 13.7 | 86.9% |
| 22 | Polyquaternium-6* | Cationic polyDADMAC | 5 | 13.7 | 99.5% | 23.8 | 99.2% |
| 23 | PEI | Polyamine | 5 | 9.8 | 98.7% | 14.5 | 87.8% |
| 24 | None | Control | — | 15.8 | 90.0% | 20.2 | 88.2% |

*indicates quaternary functionality

In summary, the crosslinking additive is a cationic polymer selected from cationic polyacrylamide, cationic poly urea-ammonium-ether, Cationic hydroxyethyl cellulose, Cationic guar, and cationic polyDADMAC, and when exposed to 10,000 ppm·h of chlorine, the filter has rejection value ranging from 86.9% to 99.2% under acid conditions.

When the cross linking additive is selected from cationic polyacrylamide, cationic poly urea-ammonium-ether, Cationic hydroxyethyl cellulose, and cationic polyDADMAC, and when exposed to 10,000 ppm·h of chlorine the filter has rejection values greater than 90% to 99.2, under acid conditions. The filter has permeance values ranging from 11.0 to 23.8 (L/m²/h/bar) when measured using the probe molecule Rose Bengal in the cross-flow apparatus.

When the filter has a crosslinking additive includes a cationic polymer and an adhesive additive including GOHSENX™K, and when exposed to 10,000 ppm·h of chlorine, the filter has a permeance value ranging from 11.0 to 23.8 L/m2/h/bar and a rejection value ranging from 86.6% to 99.5% under acidic conditions

When the filter has a crosslinking additive is a diamine polymer with at least two reactive amine groups, and an adhesive additive for adhering the membrane to the porous substrate. Similarly, when the adhesive additive includes GOHSENX™K, and when exposed to 10,000 ppm·h of chlorine, the filter has a rejection value at least 85%, and suitably a rejection in the range of 85% to 88% and a permeance value ranging from 13 to 15 L/m2/h/bar, and suitably a permeance value ranging approximately 14.5 L/m2/h/bar under acid conditions.

In addition, membranes prepared in accordance with Example 1 and FIG. 1 were also prepared to determine the point at which the reaction between a modifying and the graphene oxide sheets had progressed sufficiently far enough so the temperature of the composition can be reduced to form a stable composition. That is to say, all of, or nearly all of, the modifying agent had reacted with the graphene oxide sheets.

The procedure included adding i) 2.5 L of graphene oxide at a concentration of 10 g/L and ii) 420 mL of H₂O₂ at a concentration of 30 wt % to an autoclave which was stirred at 500 rpm and heated up to 90° C. at 0.8° C./min, and then held at 90° C. for 7 hours. Once the temperature reached 90° C., samples of the composition was withdrawn at time equals zero hrs. At this point, there had been no appreciable reaction between the graphene oxide and the modifying agent and graphene oxide is regarded as unmodified. Samples of the composition were withdrawn at one hour intervals until the reaction was stopped after 7 hours by turning off the heater and turning on the chiller.

The viscosity of the samples was measured at 20° C. using a Brookfield LVT viscometer. Due to the shear thinning nature of the graphene oxide composition, the reported viscosity is the apparent viscosity at a shear rate of 30 rpm.

Filter membranes were then prepared using the samples of the composition in accordance with Example 1 and FIG. 1 and are labelled as Samples 25 to 32 in Table 7 below. Filter membranes were prepared using TOMAC PVDF for the porous substrate, GOHSENX-K™ for the adhesive additive and polyDADMAC for the crosslinking additive. The Samples 25 to 32 comprised coupons of 42.1 cm² in area and the permeance and rejection of each were tested using a 300 ppm solution of Rose Bengal in a cross-flow apparatus operating at 2 bar.

TABLE 7
Apparent viscosity of unmodified and modified graphene oxide
composition and performance of membranes prepared therefrom

| | Reaction | Apparent | | |
|---|---|---|---|---|
| | time | viscosity | Rejection | Permeance |
| Sample | hr | mPa · s | % | L/m²/h/bar |
| 25 | 0 | 104 | 96.4% | 6.5 |
| 26 | 1 | 830 | 99.5% | 9.6 |
| 27 | 2 | 1800 | N/A | N/A |
| 28 | 3 | 1160 | 99.8% | 8.6 |
| 29 | 4 | 470 | 97.1% | 17.8 |
| 30 | 5 | 170 | 95.5% | 17.8 |
| 31 | 6 | 30 | 96.2% | 17.8 |
| 32 | 7 | <30 | 95.9% | 16.9 |

Table 7 shows that the viscosity increases as the reaction proceeds, up to a maximum after 2 hours of reaction time and thereafter the viscosity decreases. The data shows that a functioning membrane can be produced from any of samples 25 to 32, each having a rejection of Rose Bengal greater than 90%. That is to say, a stable composition was obtained for each. In addition, for the filter to have an increased permeance, the viscosity of the composition has ideally reached and passed a maximum viscosity. A maximum in the viscosity occurred somewhere in between 1 and 3 hours. For instance, a total reaction time of 4, 5, 6 and 7 hrs is preferrable. In other words, the modifying step was carried out for at least 1 to 5 hours after a maximum in the viscosity of the composition has occurred. Suitably, the modifying step was carried out for at least 2 to 4 hours after a maximum in the viscosity of the composition has occurred. In the case of sample 27, the viscosity of the composition prevented the composition from being printed onto the substrate.

In addition to steps in the examples 1 to 3, the method carried out to make may include options steps such as the following.

### Optional Addition of Reducing Agent

This step involves adding and mixing a reducing solution with the hGO suspension. Specifically, a reducing solution containing an amount of red grape skin polyphenol equal to 25% of the GO mass is measured and added to the hGO dispersion whilst the dispersion is being sheared. Typically, 5.36 g of polyphenol is added to the 2.917 L of hGO suspension while stirring the composition vigorously at a rate of 6000 rpm. The polyphenol is added slowly in stages and the composition is sheared for 15 minutes or until the composition is homogenised and a desired viscosity is achieved.

This composition was then heated to 75° C. and stirred at 100 rpm for 1 hour. The suspension obtained is then notionally referenced as an intermediate suspension.

### Optional Addition of Physical Property Modifiers

To provide a composition that is conducive to printing, an organic solvent can be added. For example, 100 ml of a graphene oxide suspension containing 8.57 g/L of graphene oxide was mixed with 100 ml of ethanol to form a 50% aqueous ethanol suspension. This resulted in changes to viscosity and surface tension that improved the application of the graphene oxide to the porous substrate.

### Optional Post-Treatment

Finally, fine control of the permeance of the substrate was carried out with a NaOCl treatment. Specifically, setting the permeance may include treating the filtration membrane by submerging the substrate in a solution of NaOCl for a period. For example, submerging the substrate in a solution of 10000 mg/L NaOCl for period of 30 minutes, increased the permeance of a PVDF-GO membrane e.g. from 20 to 30 L/m²/hr/bar.

Those skilled in the art of the present invention will appreciate that many variations and modification can be made to the example described herein without departing from the spirit and scope of the present invention.

In the claim which follows, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1-50. (canceled)

51. A filter including a porous substrate and a graphene oxide membrane on the porous substrate, wherein the graphene oxide membrane includes a crosslinking additive between graphene oxide sheets which reduces degradation of the graphene oxide membrane by chlorine.

52. The filter according to claim 51, wherein the crosslinking additive is selected from a group comprising: i) a polymer having at least one epoxide group, ii) a molecule having at least one epoxide group, iii) a cationic polymer having at least one quaternary ammonium group, iv) a polymer having at least two amine groups, or v) a molecule having at least two amine groups.

53. The filter according to claim 51, wherein the crosslinking additive includes an epoxide group for reacting with the graphene oxide.

54. The filter according to claim 51, wherein the crosslinking additive includes multiple epoxide groups, including diepoxide; preferably the multiple epoxide groups include: poly(ethylene glycol) diglycidyl ether, 1,4-butanediol diglycidyl ether, and poly(dimethylsiloxane) that is diglycidyl ether terminated

55. The filter according to claim 51, wherein the crosslinking additive has an epoxide group and an alkoxysilane group for reacting with the graphene oxide; preferably the crosslinking additive having an epoxide group and a hydrolysable silanol group is 3-glycidyloxypropl trimethoxy silane, which is also known as glymo.

56. The filter according to claim 51, wherein the crosslinking additive includes a cationic polymer, and preferably wherein the cationic polymer has cationic functionality provided by a quaternized nitrogen atom and preferably wherein the quaternized nitrogen atom is a quaternary ammonium group.

57. The filter according to claim 56, wherein the cationic polymer includes at least one of: cationic polyvinyl alcohol, cationic polyacrylamide, cationic poly-urea-ammonium-ether, cationic hydroxyethyl cellulose, cationic guar, cationic polyDADMAC.

58. The filter according to claim 56, wherein the cationic polymer is a modified polyvinyl alcohol incorporating one or more quaternary ammonium groups, such as GOHSENX™ K.

59. The filter according to claim 56, wherein the cationic polymer includes a polymer compound with at least one quaternized ammonium structure within the principal chain, in which the quaternized ammonium structure includes: pyridinium, piperidinium, piperazinium and aliphatic ammonium, and preferably
wherein the cationic polymer includes a cationic polyacrylamide which includes one or more cationic monomers such as acryloyloxyethyltrimethyl ammonium halide (preferably chloride; DAC), methyacryloyloxyethyltrimethyl ammonium halide (preferably chloride; DMC), or diallyl dimethyl ammonium halide; preferably chloride (DADMAC).

60. The filter according to claim 51, wherein the filter includes an adhesive additive for adhering the graphene oxide membrane to the porous substrate, and wherein the adhesive additive is resistant to chlorine degradation, and preferably
wherein the adhesive additive includes cationic functionality provided by a quaternized nitrogen atom, and preferably
wherein the quaternized nitrogen atom is a quaternary ammonium group.

61. The filter according to claim 60, wherein the cationic polymer is selected from a group including cationic polydiallyldimethylammonium chloride (polyDADMAC) and cationic polyvinylalchohol (such as GOHSENX™ K).

62. The filter according to claim 51, wherein the crosslinking additive is a cationic polymer selected from cationic polyacrylamide, cationic poly urea-ammonium-ether, cationic hydroxyethyl cellulose, Cationic guar and cationic polyDADMAC, and when exposed to 10,000 ppm·h of chlorine, the filter has rejection values ranging from 90% to 98.5% under alkaline conditions when measured using the probe molecule Rose Bengal in the cross-flow apparatus, and preferably
wherein the filter has permeance values ranging from 13.7 to 29.8 (L/m²/h/bar) when measured using the probe molecule Rose Bengal in the cross-flow apparatus, and preferably the filter has rejection value ranging from 86.9% to 99.2% under acid conditions when measured using the probe molecule Rose Bengal in the cross-flow apparatus.

63. The filter according to claim 51, wherein the filter includes an adhesive additive for adhering the graphene oxide membrane to the porous substrate, and wherein the adhesive additive is resistant to chlorine degradation, and the adhesive additive is selected from a group including cationic polydiallyldimethylammonium chloride (polyDADMAC) and cationic polyvinylalchohol (such as GOHSENX™ K).

64. The filter according to claim 51, wherein the filter has a crosslinking additive including a cationic polymer and an adhesive additive including GOHSENX™ K, and when exposed to 10,000 ppm·h of chlorine, the filter has a permeance value ranging from 13.7 to 29.8 L/m2/h/bar and a rejection value ranging from 90.7% to 98.5% under alkaline conditions when measured using the probe molecule Rose Bengal in the cross-flow apparatus, and preferably the filter has a permeance value ranging from 11.0 to 23.8 L/m2/h/bar and a rejection value ranging from 86.6% to 99.5% under acidic conditions when measured using the probe molecule Rose Bengal in the cross-flow apparatus.

65. The filter according to claim 51, wherein the filter has a crosslinking additive including a diamine polymer with at least two reactive amine groups, and an adhesive additive for adhering the membrane to the porous substrate.

66. The filter according to claim 51, wherein the porous substrate is selected from the group comprising a metallic substrate, a ceramic substrate, or a polymeric substrate such as polyvinylidene difluoride.

67. A method of making a filter having a porous substrate and a graphene oxide membrane, wherein the method includes:
applying a composition containing graphene oxide sheets to the porous substrate to form the graphene oxide membrane, and
incorporating a crosslinking additive in the graphene oxide filter membrane to form crosslinks between graphene oxide sheets to reduce degradation on exposure to halides such as chlorine.

68. The method according to claim 67, wherein the method includes selecting the crosslinking additive and the crosslinking additive is selected from a group comprising: i) a polymer having at least one epoxide group, ii) a molecule having at least one epoxide group iii) a cationic polymer having at least one quaternary ammonium group, iv) a polymer having at least two amine groups, or v) a molecule having at least two amine groups.

69. The method according to claim 67, wherein the crosslinking additive includes a cationic polymer having a quaternary ammonium group, and preferably wherein the cationic polymer includes at least one of: cationic polyvinyl alcohol, cationic polyacrylamide, cationic poly-urea-ammonium-ether, cationic hydroxyethyl cellulose, cationic guar, cationic polyDADMAC.

70. The method according to claim 67, wherein the step of incorporating the crosslinking additive in the graphene oxide filter membrane includes a post treatment step of applying the crosslinking additive to the graphene oxide membrane once dried after the membrane has been applied to the porous substrate, and preferably
wherein the post treatment step includes activating the crosslinking additive to complete crosslinking between the graphene oxide sheets, and preferably
wherein activating the crosslinking additive includes heating the substrate and the membrane on the substrate above 50° C. for at least 1 hour, and to a temperature of 75° C. for at least 2 hours, and preferably
wherein activating the crosslinking additive includes applying a catalyst, such as aluminium acetylacetonate to the graphene oxide membrane, and preferably
wherein the step of incorporating the crosslinking additive in the graphene oxide filter membrane may include adding the crosslinking additive to a suspension of graphene oxide sheets prior to the suspension being applied to the porous substrate, and preferably wherein the method includes applying an adhesive additive to a porous substrate to facilitate adhesion of the graphene oxide membrane to the substrate, and preferably
wherein the adhesive additive is cationic polymer having a quaternary ammonium group,
wherein the adhesive additive is a cationic polyvinylalchohol which is commercially available under the trade name GOHSENX™ K Series from Mitsubishi Chemical, and preferably
wherein the method includes the steps of i) adding a modifying agent to a composition containing the graphene oxide feed suspension and ii) modifying the graphene oxide by mixing the composition under elevated temperature conditions so that the modifying agent reacts with the graphene oxide sheets to create imperfections in the graphene oxide sheets, wherein progress of the reaction is stopped by reducing the temperature of the composition to stabilise the composition so that the composition can be applied to a substrate to form a graphene oxide filtration membrane, and preferably
wherein the step of adding the modifying agent includes adding the modifying agent to the graphene oxide mass in the feed suspension is in a range of less than or equal to 15 to 1, 12 to 1, 10 to 1, 9 to 1, 8 to 1, 7 to 1, 6 to 1, 5 to 1, 4 to 1, 3 to 1, or 2 to 1, and preferably
wherein the step of modifying the graphene oxide includes heating the composition to a temperature in the range of from 50° C. to about 200° C., or preferably about 80° C. to about 150° C., or preferably in the range of 50 to 98° C., and ideally in the range of 80 to 90° C. whilst mixing
wherein the step of mixing the composition occurs for a period of 0.5 hr to 7 hrs, and suitably for a period from 1 hr to 6 hrs, and preferably
wherein the step of modifying the graphene oxide is carried out for at least 1 to 5 hours after a maximum in viscosity of the composition has occurred, and preferably from 3 to 5 hours after a maximum in viscosity of the composition, and preferably
wherein the modifying agent is selected from a group including hydrogen peroxide, peracetic acid, benzoyl peroxide, sodium perborate, ammonium hydroxide, or alkali hydroxides such as sodium hydroxide and potassium hydroxide.
